(19) United States
(12) Patent Application Publication
(10) Pub. No.: US 2015/0011278 A1
(43) Pub. Date: Jan. 8, 2015

(54) METHOD FOR PROVIDING AN ONLINE SPORTS GAME PROVIDING ABILITY COMPENSATION FOR BEGINNER USERS, AND SYSTEM FOR SAME

(71) Applicant: Intellecutal Discovery Co., Ltd., Seoul (KR)

(72) Inventor: Woo Hyun Kim, Seoul (KR)

(73) Assignee: Intellectual Discovery Co., Ltd., Seoul (KR)

(21) Appl. No.: 14/363,984

(22) PCT Filed: Dec. 4, 2012
(86) PCT No.: PCT/KR2012/010432

§ 371 Date: Jun. 9, 2014

(30) Foreign Application Priority Data
Dec. 9, 2011 (KR) 10-2011-0132414

(51) Int. Cl. A63F 13/795; A63F 13/58; A63F 13/812

(52) U.S. Cl. CPC A63F 13/795; A63F 13/812; A63F 13/58
USPC 463/2

(57) ABSTRACT

A method for providing an online sports game is implemented in an online sports game providing system that provides an online sports game to users through a plurality of game clients. The method includes (a) checking whether the plurality of users of each participating team of a pair of teams participating in a match have relationships of friendship, (b) strengthening and compensating for the ability of player characters belonging to a sports team of first users at the lowest level, and (c) providing a match for an online sports game. By compensating for and increasing the ability of player characters belonging to a beginner user sports team, a beginner user may enjoy the game on equal terms with an existing user, and the rate of new user dropout may be minimized.

### TECHNICAL FIELD

The present disclosure relates to a game providing technique, and more particularly, to a method and a system for providing an online spots game, capable of enabling beginners to easily enjoy the game by providing ability compensation to the beginners.

### BACKGROUND ART

With development of computing devices and network environments, online-based games have largely been being developed

These online-based games are recognized to be different from offline games that perform predetermined actions in a match against a conventional program, in facilitating mutual connections between users. In this respect, the online-based games have rapidly been being developed.

Initial online games are mostly multiplayer online role playing games (MORPGs). However, various kinds of online games have gradually been provided due to bandwidth expansion of networks and development of computing devices. As a result, sports online games for providing users with online games of ball sports such as a soccer, a basketball, and a baseball are widely provided.

In the online sports games, securing a high residual rate of new users is one of very essential factors for managing the games. This is because game level, game knowhow, and the like of old users which are increased as the games are in progress act as entry barriers against new users. These entry barriers deduce interests of new users in the games in an early stage, thereby increasing a defection rate on the new users.

The defection rate of new users is conventionally decreased by, e.g., supplying predetermined items without cost. However, this method merely provides a temporary effect, but is limited to fill a gap between new users and old users.

### DISCLOSURE

### Technical Problem

The present disclosure has been made in an effort to provide a technique for providing an online sports game, having advantages of enabling a new user to equivalently play an online sports game against old users by compensating an ability value of a player character pertaining to a sports team of the new user

The present disclosure has also been made in an effort to provide a technique for providing an online sports game, having advantages of being capable of strengthening a community between users by compensating an ability of a sports team of a new user when users who have friendships with each other pertain to the same team.

Further, the present disclosure has been made in an effort to provide a technique for providing an online sports game, having advantages of being capable of more precisely compensating an ability value of a player character of a new user by increasing the ability value in consideration of a game level of the new user.

### Technical Solution

An exemplary embodiment provides a method for providing an online sports game, performed by a system for providing the online sports game, which is connectable to a plurality of game clients through a network, to provide the online sports game to users through the game clients. The method includes: (a) receiving a request of starting a matching game for a pair of matching teams each of which is configured by participation of a plurality of users and checking whether the users who participate in each of the pair of matching teams have a friendship with each other; if the corresponding users have the friendship, (b) performing compensation by increasing ability values of player characters pertaining to a sports team of a first user having the lowest level among the users pertaining to the corresponding matching team; and (c) providing the sports online game for the pair of matching teams by applying the compensated result.

An exemplary embodiment provides a method for providing an online sports game, performed by a system for providing the online sports game, which is connectable to a plurality of game clients through a network, to provide the online sports game to users through the game clients

The method includes: (a) receiving a request of starting a matching game for a pair of matching teams each of which is configured by participation of a plurality of users; (b) checking whether the users who participate in each of the pair of matching teams have a friendship with each other; if the corresponding users have the friendship, (c) checking whether the level of the first user having the lowest level among the users pertaining to the corresponding matching team is equal to or lower than a predetermined level and, if the level of the first user is equal to or lower than the predetermined level, performing compensation by increasing the ability values of the player characters pertaining to the sports team of the first user; and (d) providing the matching sports online game for the pair of matching teams by applying the compensated result.

An exemplary embodiment provides a method for providing an online sports game, performed by a system for providing the online sports game, which is connectable to a plurality of game clients through a network, to provide the online sports game to users through the game clients. The method includes: (a) receiving a request of starting a matching game for a pair of matching teams each of which is configured by participation of a plurality of users; (b) checking the users who participate in each of the pair of matching teams have pertained to the same matching team at least one time or more; if the users have pertained to the matching team, (c) checking whether the level of the first user having the lowest level among the users pertaining to the matching team is equal to or lower than a predetermined level and, if the level of the first user is equal to or lower than the predetermined level, performing compensation by increasing the ability values of the player characters pertaining to the sports team of the first user with a weight value proportional to a difference between the predetermined level and the level of the first user; and (d) providing the matching sports online game for the pair of matching teams by applying the compensated result.

An exemplary embodiment provides a method for providing an online sports game, performed by a system for providing the online sports game, which is connectable to a plurality of game clients through a network, to provide the online sports game to users through the game clients. The method includes: (a) receiving a request of starting a matching game for a first matching team and a second matching team each of which is configured by participation of a plurality of users; (b) checking whether the users who participate in the first matching team have a friendship with each other; if the users have the friendship, (c) comparing an average level of the users who participate in the second matching team and a level of a first user having the lowest level among the users pertaining to the first matching team; as a result of comparing them, if the level of the first user is lower than the average level, (d) performing compensation by increasing ability values of player characters pertaining to a sports team of the first user with a weight value proportional to a difference between the average level and the level of the first user; (e) providing the matching sports online game for the pair of matching teams by applying the compensated result.

An exemplary embodiment provides a system for providing an online sports game, which is connectable to a plurality of game clients through a network, to provide the online sports game to users through the game clients. The system includes a user database, a match organizer, and a game providing controller

A user interface stores level information, information related to a managing sports team, and friend information for each user of the online sports game. A match organizer organizes a first matching team and a second matching team each of which is configured by a plurality of users. A game providing controller checks whether the users pertaining to the first and second matching teams have a relationship by using the user database and, if the users have the relationship, performs compensation by increasing ability values of at least some of player characters pertaining to a sports team of a first user who has the lowest level among the users pertaining to the corresponding matching team.

An exemplary embodiment provides a computer readable recording medium recorded with a program for executing a method for providing a game service by a terminal. The program is drivable by a system for providing the online sports game, which is connectable to a plurality of game clients through a network, to provide the online sports game to users through the game clients, the program implementing: (a) a process of receiving a request of starting a matching game for a pair of matching teams each of which is configured by participation of a plurality of users and checking whether the users who participate in each of the pair of matching teams have a friendship with each other; if the corresponding users have the friendship; (b) a process of performing compensation by increasing ability values of player characters pertaining to a sports team of a first user having the lowest level among the users pertaining to the corresponding matching team; and (c) a process of providing the matching sports online game for the pair of matching teams by applying the compensated result.

An exemplary embodiment provides a computer readable recording medium recorded with a program for executing a method for providing a game service by a terminal. The program is drivable by a system for providing the online sports game, which is connectable to a plurality of game clients through a network, to provide the online sports game to users through the game clients, the program implementing: (a) a process of receiving a request of starting a matching game for a pair of matching teams each of which is configured by participation of a plurality of users; (b) a process of checking whether the users who participate in each of the pair of matching teams have a friendship with each other; if the corresponding users have the friendship, (c) a process of checking whether the level of the first user having the lowest level among the users pertaining to the corresponding matching team is equal to or lower than a predetermined level and, if the level of the first user is equal to or lower than the predetermined level, performing compensation by increasing the ability values of the player characters pertaining to the sports team of the first user; and (d) a process of providing the matching sports online game for the pair of matching teams by applying the compensated result.

An exemplary embodiment provides a computer readable recording medium recorded with a program for executing a method for providing a game service by a terminal. The program is drivable by a system for providing the online sports game, which is connectable to a plurality of game clients through a network, to provide the online sports game to users through the game clients, the program implementing: (a) a process of receiving a request of starting a matching game for a pair of matching teams each of which is configured by participation of a plurality of users; (b) a process of checking the users who participate in each of the pair of matching teams have pertained to the same matching team at least one time or more; if the users have pertained to the matching team, (c) a process of checking whether the level of the first user having the lowest level among the users pertaining to the matching team is equal to or lower than a predetermined level and, if the level of the first user is equal to or lower than the predetermined level, performing compensation by increasing the ability values of the player characters pertaining to the sports team of the first user with a weight value proportional to a difference between the predetermined level and the level of the first user; and (d) a process of providing the matching sports online game for the pair of matching teams by applying the compensated result.

An exemplary embodiment provides a computer readable recording medium recorded with a program for executing a method for providing a game service by a terminal. The program is drivable by a system for providing the online sports game, which is connectable to a plurality of game clients through a network, to provide the online sports game to users through the game clients, the program implementing: (a) a process of receiving a request of starting a matching game for a first matching team and a second matching team each of which is configured by participation of a plurality of users; (b) a process of checking whether the users who participate in the first matching team have a friendship with each other; if the users have the friendship, (c) a process of comparing an average level of the users who participate in the second matching team and a level of a first user having the lowest level among the users pertaining to the first matching team; as a result of comparing them, if the level of the first user is lower than the average level, (d) a process of performing compensation by increasing ability values of player characters pertaining to a sports team of the first user with a weight value proportional to a difference between the average level and the level of the first user; (e) a process of providing the matching sports online game for the pair of matching teams by applying the compensated result.

### Advantageous Effects

In accordance with the disclosed techniques of this disclosure, it is possible to provide an effect of minimizing a defection rate on new users by enabling a new user to equivalently play an online sports game against old users by compensating an ability value of a player character pertaining to a sports team of the new user.

In accordance with the disclosed techniques of this disclosure, it is possible to provide another effect of being capable of strengthening a community between users by compensating an ability of a sports team of a new user when users who have friendships with each other pertain to the same team.

In accordance with the disclosed techniques of this disclosure, it is possible to provide yet another effect of being capable of more precisely compensating an ability value of a player character of a new user by increasing the ability value in consideration of a game level of the new user.

### DESCRIPTION OF THE DRAWINGS

FIG. 1 is a reference view showing a system for providing an online sports game and game clients in accordance with an exemplary embodiment.

FIG. 2 is a schematic diagram showing the system for providing an online sports game in accordance with the present exemplary embodiment.

FIG. 3 is a schematic diagram showing a system for providing an online sports game in accordance with an exemplary.

FIG. 4 is a reference view showing a user data stored in a user database shown in FIG. 2 and FIG. 3.

FIG. 5 is a reference view showing an example of information related to a player character used in an online sports game in accordance with the present exemplary embodiment.

FIG. 6 is a reference view showing an example of a player whose ability value is compensated by applying an uniform item thereto.

FIG. 7 is a flowchart for explaining a method for providing an online game in accordance with an exemplary embodiment.

FIG. 8 is a flowchart for explaining a method for providing an online game in accordance with another exemplary embodiment.

FIG. 9 is a flowchart for explaining a method for providing an online game in accordance with yet another exemplary embodiment.

FIG. 10 is a flowchart for explaining a method for providing an online game in accordance with yet another exemplary embodiment.

### MODE FOR INVENTION

The detailed descriptions of disclosed techniques are merely exemplary embodiments for structural and functional explanation, serve only for describing the disclosed techniques, and by no means limit or restrict the spirit and scope of the disclosed techniques. In other words, the exemplary embodiments may be modified in various ways and have many different forms, and thus the scope of the disclosed techniques shall be construed as including equivalents which may realize the spirit of the appended claims.

The meaning of terms used in this specification should be understood as follows.

Terms such as “first” and “second” may be used in describing various elements, but the above elements shall not be restricted to the above terms. The above terms are used only to distinguish one element from the other. For instance, the first element may be named the second element, and vice versa.

When one element is described as being “connected” or “accessed” to another element, it shall be construed as being connected or accessed to another element directly but also as possibly having yet another element in between. On the other hand, if one element is described as being “directly connected” or “directly accessed” to another element, it shall be construed that there is no other element in between. This is also true of other expressions for explaining a relationship between elements, i.e., “between” and “directly between” or “adjacent to” and “directly adjacent to”

Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Identification codes (e.g., a, b, and c) of each step are merely used for better comprehension and ease of description, not indicating a specific order of the steps, and the steps may be performed in a different order from a described order, unless clearly limited otherwise. Specifically, the steps may be performed in the same order as the described order, may substantially simultaneously be performed, or may be performed in the reverse order.

The disclosed techniques may be embodied as computer-readable codes in a computer readable recording medium, and the computer readable recording medium may include all kinds of recording devices for storing data that is readable by a computer system. Examples of the computer readable recording medium includes a ROM, a RAM, a CD-ROM, a magnetic tape, a floppy disk, an optical data storage device, and the like, and further includes a device for storing data transmitted in a form of carrier waves (e.g., transmission through the Internet). Further, a computer readable recording medium recorded with programs as described above may be distributed to a computer system connected through a network and thus store and execute a computer readable code by a distributed manner

Unless otherwise defined, all terms used herein have the same meaning as how they are generally understood by those of ordinary skill in the art to which the disclosure pertains. Any term that is defined in a general dictionary shall be construed to have the same meaning in the context of the relevant art, and, unless otherwise defined explicitly, shall not be interpreted to have an idealistic or excessively formalistic meaning.

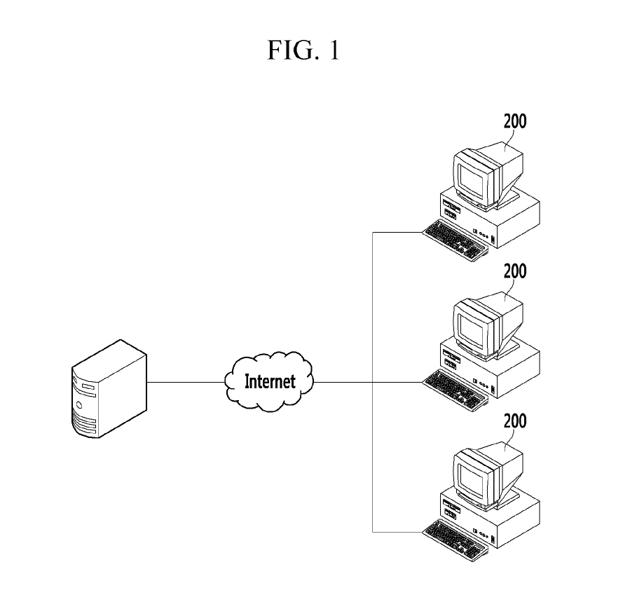

FIG. 1 is a reference view showing a system for providing an online sports game and game clients in accordance with an exemplary embodiment.

The system 100 for providing an online sports game (hereinafter, referred to as a game providing system) may simultaneously provide a sports game to at least one user through an online network environment. The online sports game provided by the game providing system 100 is a sports game for a plurality of users. For example, the online sports game may be an sports such as a soccer, a baseball, a basketball, or a handball that is performed by forming teams, which is embodied as an online game.

The game providing system 100 may provide an online sports match (hereinafter, referred to as a match simply)

The game providing system 100 may provide various games configured by plurality of matches such as tournaments and leagues as well as one simple game.

The game providing system 100 may provide a player versus player (PVP) online match that is played between users and a player versus environment (PVE) match that is played between a user and an artificial intelligence. Further, the game providing system 100 may provide a multi-PVP match that is played between a plurality of users and a multi-PVE match that is played between a plurality of users and an artificial intelligence.

The game providing system 100 may provide a predetermined artificial intelligence to a team of a specific user. For example, in a basketball match, each team of which has 5 members, one player character of a team may be controlled by a user, and the remaining 4 player characters may perform predetermined actions (events) such as position change and automatic defense by an artificial intelligence (game engine) without being controlled by the user.

The game providing system 100 may exchange data with at least one game client 200 at least partially in real time to provide an online sports game.

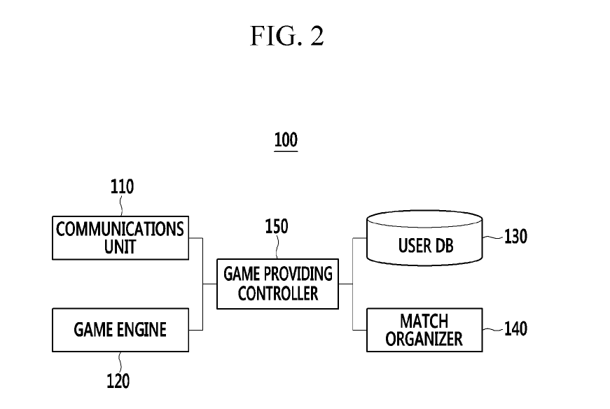

This game providing system 100 will be described below in more detail with reference to FIG. 2.

The game client 200 serves as a game providing means that may be driven in a user terminal. The user terminal is a terminal, such as a PC, a tablet PC, or a smartphone, including a central processing unit and a memory.

The game client 200 may provide a sports game to a user by accessing or maintaining communications with the game providing system 100. In another exemplary embodiment, the game client 200 may load at least one part of a game engine for driving a game. For example, at least one part of predetermined operation required to provide a sport online game may be performed by the game client 200.

FIG. 2 is a schematic diagram showing the system for providing an online sports game in accordance with the present exemplary embodiment.

Referring to FIG. 2, the game providing system 100 may include a communications unit 110, a game engine 120, a user database 130, a match organizer 140 and a game providing controller 150.

The communications unit 110 may set or maintain a communications environment for, e.g., providing a game with the game client 200 according to the control of the game providing controller 150.

The game engine 120 serves as an element for driving a game, to provide a user with a sports game by being connected with the game client 200. In the present exemplary embodiment, the game engine 120 has been described to be separated from the game providing controller 150. However, in another exemplary embodiment, the game engine 120 may be embodied as a part of the game providing controller 150. In the present exemplary embodiment, at least one part of the game engine 120 may be loaded in the game client 200.

The user database 130 may store information related to each user of an online sports game

Specifically, the user database 130 may store level information of a user in a game, information related to a sports team in an online game managed by the user (hereinafter, referred to as managing sports team), information related to players pertaining to the managing sports team, information related to used items or holding items, and information related to other users who have a friendship with the user (hereinafter, referred to as friends).

The match organizer 140 may determine two teams to be matched

Specifically, the match organizer 140 may organize a plurality of matching (PVP) teams (e.g., two teams) by setting at least one user to pertain to each team.

The match organizer 140 transmits information related to the organized matching teams (e.g., identification information related to the users pertaining to each team) to the game providing controller 150, thereby facilitating performance of a corresponding match game.

The game providing controller 150 may check whether there is a beginner in a plurality of matching teams and, if the beginner exists, performs compensation to increase an ability value of a team including the beginner to provide the matching sports online game based on the compensated ability value.

In the present exemplary embodiment, the game providing controller 150 may perform ability value compensation when users pertaining to a matching team have a relationship with each other. Specifically, the game providing controller 150 may check whether users pertaining to a plurality of matching teams have a predetermined relationship by using the user database 130 and, if the users have the predetermined relationship, may perform compensation to increase ability values of at least some of player characters pertaining to a sports team of a beginner (i.e., a user having the lowest ability value among the users pertaining to the sports team).

Herein, the predetermined relationship may be a friendship. To that end, the game providing controller 150 may search the user database 130 for friendship information of the users pertaining to each matching team to check whether the users have the friendship with each other.

In the present exemplary embodiment, when the users have no friendship, the game providing controller 150 may check whether the users pertaining to the matching team perform setting to have the friendship. When receiving the setting to have the friendship, the game providing controller 150 may set the corresponding users to have the friendship and perform updating of the user database by storing pertinent information therein.

In the present exemplary embodiment, the game providing controller 150 may determine a user is a beginner based on a level of the user. Specifically, the game providing controller 150 may check whether the level of the user having the lowest ability value is lower than a predetermined level (beginner level) among the users pertaining the matching teams to recognize the user having the lowest ability value as a beginner and, if it is equal to or lower than the beginner level, may perform compensation by increasing ability values of player characters of a sports team of the user having the lowest ability value.

In the present exemplary embodiment, the game providing controller 150 may determine an ability value to be compensated by differently setting a weight value according to a level range of each user. Specifically, the game providing controller 150 may use a weight value that is in proportion to the difference between the predetermined level and the level of the user to increase the ability values of the player characters pertaining to the sports team of the user, thereby performing the compensation.

In the present exemplary embodiment, the game providing controller 150 may determine an ability value to be compensated by comparing an average level of a counterpart team with the level of the beginner. Specifically, the game providing controller 150 may compare an average level of users pertaining to the counterpart team with the level of the beginner and, if the level of the beginner is lower than the average level of the counterpart team, may increase the ability values of the player characters pertaining to the sports team of the beginner by using the weight value that is in proportion to the difference therebetween, thereby performing the compensation.

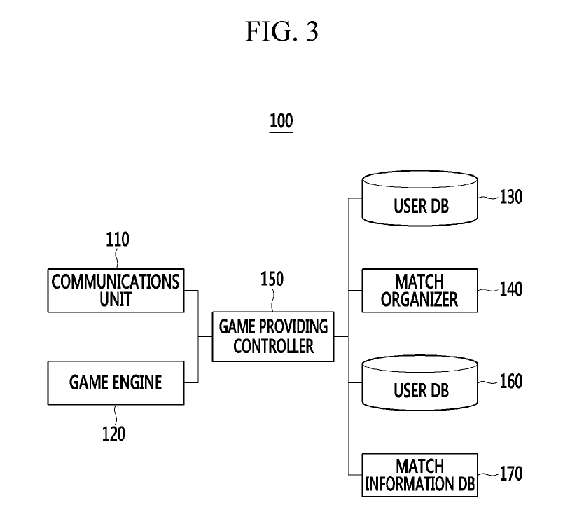

FIG. 3 is a schematic diagram showing a system for providing an online sports game in accordance with an exemplary embodiment. In the exemplary embodiment shown in FIG. 3, an item is used to perform compensation for strengthening the sports team pertaining to the beginner. Hereinafter, the exemplary embodiment shown in FIG. 3 will be described, and the same descriptions as described in FIG. 2 and corresponding descriptions thereof will be omitted.

Specifically, referring to FIG. 3, the game providing system 100 may further include an item database 160 or a match information database 170 in addition to the constituent elements shown in FIG. 2.

The item database 160 may store information related to various items provided in the online sports game.

In the present exemplary embodiment, the item database 160 may store information related to a uniform item that increases an ability value of a player character by being applied to the player character. Herein, the uniform item may be strengthened at a predetermined number of times, and a range of the ability value that may be increased by the uniform item may be raised according to how many times the uniform item is strengthened.

The game providing controller 150 may increase an ability value by applying an item stored in the item database 160 to the sports team of the beginner.

In the present exemplary embodiment, the game providing controller 150 may determine a range of the ability value to be increased in consideration of the level of the beginner and how many times the item is strengthened (strengthening number of the item). Specifically, the game providing controller 150 may set a first weight value for the level of the beginner and a second weight value for the strengthening number of the uniform item. The game providing controller 150 may determine a uniform item having a predetermined strengthening number in such a way so as to maintain a value obtained by multiplying the first weight value and the second weight value in a range.

In this respect, a table 1 is shown as follows for example.

TABLE 1

| | Strengthened uniform card | Compensated |
|---|---|---|
| User level | for compensation | player level |
| 1-5 | 9 | 100 LV |
| 5-10 | 7 | 75 LV |
| 11-15 | 5 | 50 LV |
| 16-20 | 5 | 50 LV |

Referring to the example shown in Table 1, a uniform item strengthened by +9 is supplied to a beginner whose level ranges from 1 to 5, while a uniform item strengthened by +5 is supplied to a beginner whose level ranges from 16 to 20. In Table 1, the “compensated player level” indicates a level of a player character compensated when a strengthened uniform card is mounted.

In the present exemplary embodiment, the game providing controller 150 may determine a range of the ability value to be increased in consideration of the level of the beginner and an average level of the counterpart team. Specifically, the game providing controller 150 may calculate a first weight value proportional to the difference between the level of the beginner and the average level of the counterpart team, and determine a uniform item having a strengthening number corresponding to the first weight value.

The match information database 170 may store matching information. Herein, the matching information may be used to check a relationship between users configuring matching teams.

In the present exemplary embodiment, the game providing controller 150 may perform ability value compensation when the users pertaining to the matching teams play a match together. Specifically, the game providing controller 150 may check whether the users who participate in each one of a pair of matching teams have pertained to the same matching team at least one time or more by using the match information database 170 and, if so, check whether the level of a beginner pertaining to the corresponding team is equal to or smaller than the predetermined level. If the level of the beginner is equal to or smaller than the predetermined level, the game providing controller 150 may perform compensation by increasing ability values of player characters pertaining to a sports team of the beginner with a weight value proportional to the difference between the predetermined level and the level of the beginner.

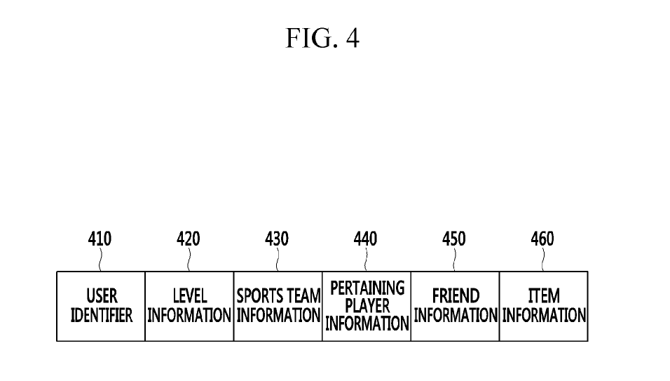

FIG. 4 is a reference view showing a user data stored in a user database shown in FIG. 2 and FIG. 3.

Referring to FIG. 4, user data may include at least one of a user identifier 410, a level information 420, a sports team information 430, a pertaining player information 440, a friend information 450, and an item information 460.

The user identifier 410 is an identifier having an inherent value per user. The game providing system 100 may identify users by using the user identifier 410.

The level information 420 is information obtained by digitizing the level of a corresponding user in a game.

The sports team information 430 is information related to a sports team managed by a corresponding user in a game. The sports team information 430 may include data such as a team name and a team score.

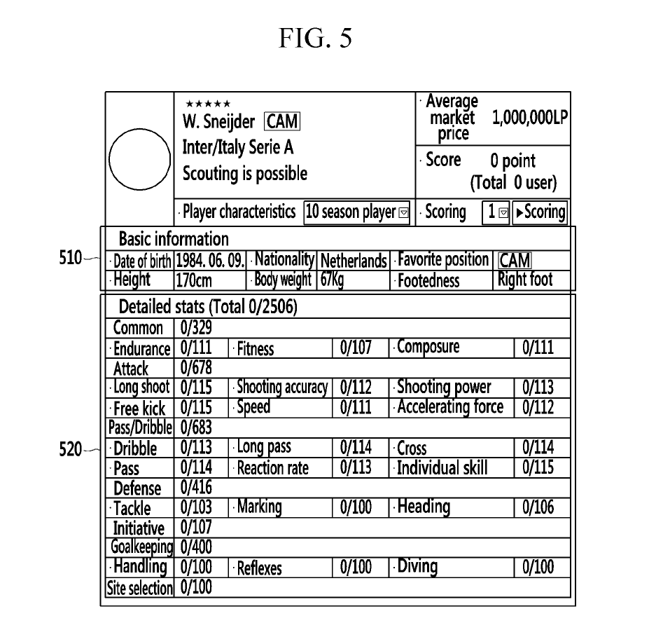

The pertaining player information 440 may include information related to player characters pertaining to a sports team of a user. The player character will be described later in more detail with reference to FIG. 5.

The friend information 450 may include information related to other users who have a friendship with the corresponding user.

The item information 460 may include related to an item that is being used or held by the user.

FIG. 5 is a reference view showing an example of information related to a player character used in an online sports game in accordance with the present exemplary embodiment.

The player character may be configured by basic information 510 and stat information 620.

The basic information 610 indicates general information related to a corresponding player character. For example, the basic information 610 may include basic items such as name, age, nationality, height, body weight, footedness, and position of a corresponding player character.

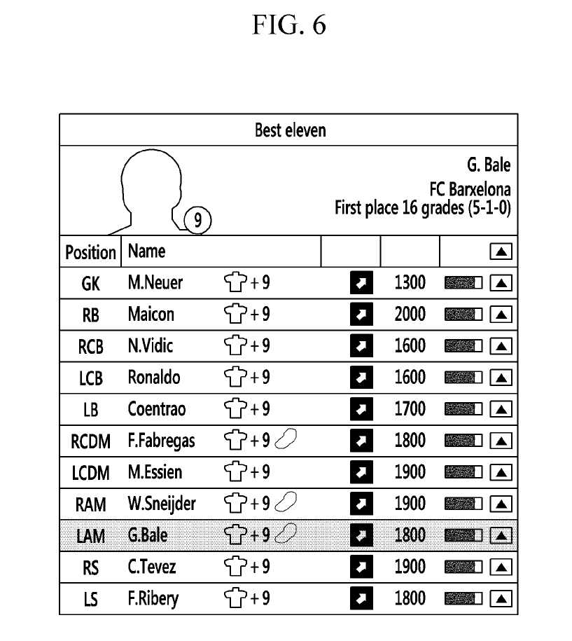

The stat information 620 indicates ability value information related to a corresponding player character applied in a game. FIG. 6 shows an example of a soccer online game, and a value according to ability is provided per character by dividing ability values into common, attack, pass/dribble, defense, and goalkeeping. However, the example shown therein is merely an example, and thus it shall be obvious that such divisions may be represented as other divisions or numerical ranges.

The disclosed technique provides an ability value as numerical data related to player characters as shown in FIG. 5, and thus the ability value of a corresponding player character may be compensated by, e.g., using the aforementioned uniform item. For example, the uniform item may have additional ability value corresponding to stat information, and the disclosed technique may perform ability value compensation by applying the additional ability value of the uniform item to the stat information of the corresponding player character. FIG. 6 is a reference view showing an example of a player whose ability value is compensated by applying an uniform item thereto. The example shown therein shows a number obtained by adding the stats of all play characters instead of stat stars.

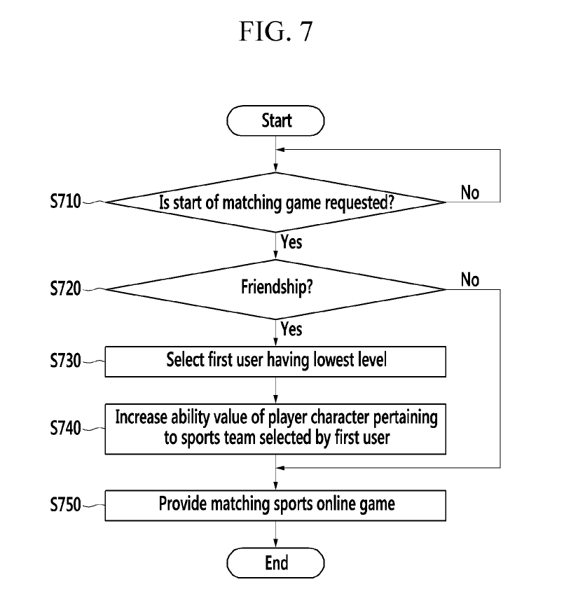

Hereinafter, various exemplary embodiments of a method of providing an online sports game will be described with reference to FIG. 7 to FIG. 10. The following exemplary embodiments are performed in the aforementioned game providing system 100, and thus the corresponding descriptions will not be repeated. However, a person of an ordinary skill in the art may understand the exemplary embodiments of the method for providing an online sports game from the aforementioned descriptions more clearly.

FIG. 7 is a flowchart for explaining a method for providing an online game in accordance with an exemplary embodiment.

The method for providing an sports game in accordance with the exemplary embodiment will be described with reference to FIG. 7. When receiving a request of starting a matching game for a pair of matching teams each of which is configured by participation of a plurality of users (Yes, step S710), the game providing system 100 may check whether the users who participate in the corresponding team of the pair of matching teams have a friendship with each other (step S720).

When the corresponding users have the friendship (Yes, step S720), the game providing system 100 selects a first user having the lowest level among the users pertaining to the corresponding matching team (step S730) and performs compensation by increasing the ability values of the player characters pertaining to a sports team of the first user (step S740).

The game providing system 100 may provide the matching sports online game for the pair of matching teams by applying the compensated result.

In the present exemplary embodiment, when the corresponding users do not have the friendship (No, step S720), the game providing system 100 may check whether the users who participate in the corresponding matching team perform setting to have a friendship.

In another exemplary embodiment for step S740, the game providing system 100 may perform compensation by providing an item for increasing the ability values of at least some of the player characters pertaining to the sports team of the first user.

Herein, the item for increasing the ability values may be a uniform item that may perform the strength at a predetermined number of times, and the game providing system 100 may set a first weight value for the level of the first user and a second weight value for a strengthening number of times at which the strength is performed and determine a uniform item having a predetermined strengthening number in such a way so as to maintain a value obtained by multiplying the first weight value and the second weight value in a range. As a result, the uniform item may be determined to prevent excessive compensation for a beginner (first user).

In another exemplary embodiment for step S740, the game providing system 100 may perform compensation by temporarily increasing the ability value of at least one play character pertaining to the sports team of the first user in the only case of the provided matching game. Specifically, the compensation may be performed by temporarily adjusting the stat information of the corresponding player character.

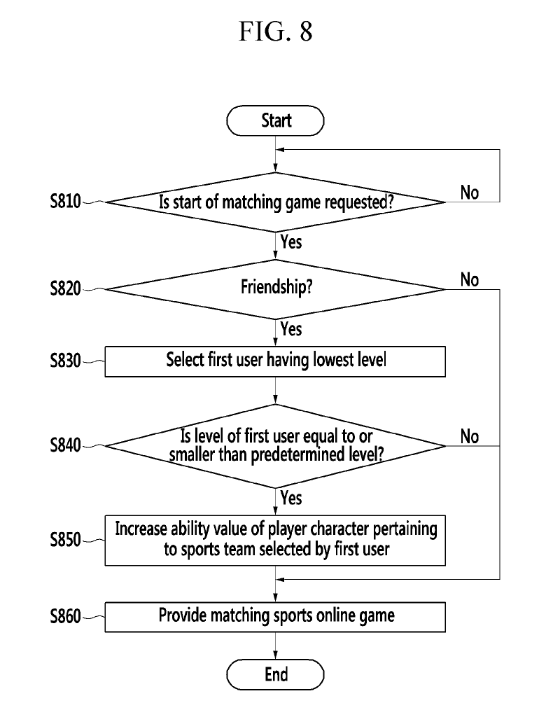

FIG. 8 is a flowchart for explaining a method for providing an online game in accordance with another exemplary embodiment. In the exemplary embodiment of FIG. 8, the ability value is increased by comparing the level of the beginner and the predetermined level.

The method for providing an sports game in accordance with the exemplary embodiment will be described with reference to FIG. 8. When receiving a request of starting a matching game for a pair of matching teams each of which is configured by participation of a plurality of users (Yes, step S810), the game providing system 100 may check whether the users who participate in the corresponding team of the pair of matching teams have a friendship with each other (step S820).

When the corresponding users have the friendship (Yes, step S820), the game providing system 100 selects a first user having the lowest level among the users pertaining to the corresponding matching team (step S830), and checks whether the level of the first user is equal to or smaller than the predetermined level (step S840).

If so (Yes, step 840), the game providing system 100 performs compensation by increasing the ability values of the player characters pertaining to a sports team of the first user (step S850), and provide the matching sports online game for the pair of matching teams by applying the compensated result (step S860).

In another exemplary embodiment for step S850, the game providing system 100 may provide an item for increasing an ability value of at least one player character pertaining to the sports team of the first user.

Herein, the item for increasing the ability values may be a uniform item that may perform the strength at a predetermined number of times, and the game providing system 100 may set a first weight value for the level of the first user and a second weight value for the strengthening number of the uniform item and determine a uniform item having a predetermined strengthening number in such a way so as to maintain a value obtained by multiplying the first weight value and the second weight value in a range.

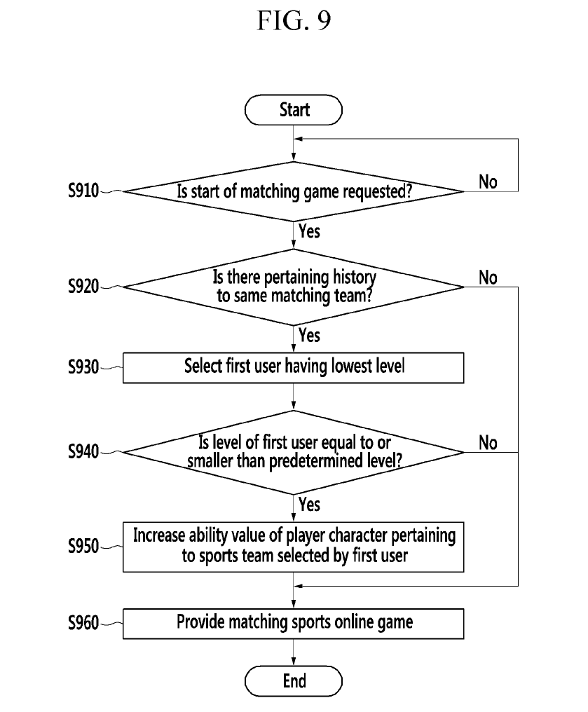

FIG. 9 is a flowchart for explaining a method for providing an online game in accordance with yet another exemplary embodiment. In the exemplary embodiment of FIG. 9, the ability value compensation is performed by determining whether to pertain to the same matching team previously.

The method for providing an sports game in accordance with the exemplary embodiment will be described with reference to FIG. 9. When receiving a request of starting a matching game for a pair of matching teams each of which is configured by participation of a plurality of users (Yes, step S910), the game providing system 100 may check whether the users who participate in each of the pair of matching teams have pertained to the same matching team at least one time or more (step S920).

If so (Yes, S920), the game providing system 100 selects a first user having the lowest level among the users pertaining to the corresponding matching team (step S930), and checks whether the level of the first user is equal to or lower than the predetermined level (step S940).

If the level of the first user is equal to or lower than the predetermined level (Yes, step S940), the game providing system 100 may perform compensation by increasing ability values of player characters pertaining to a sports team of the first user with a weight value proportional to the difference between the level of the first user and the predetermined level, and provide the matching sports online game for the pair of matching teams by applying the compensated result (step S960).

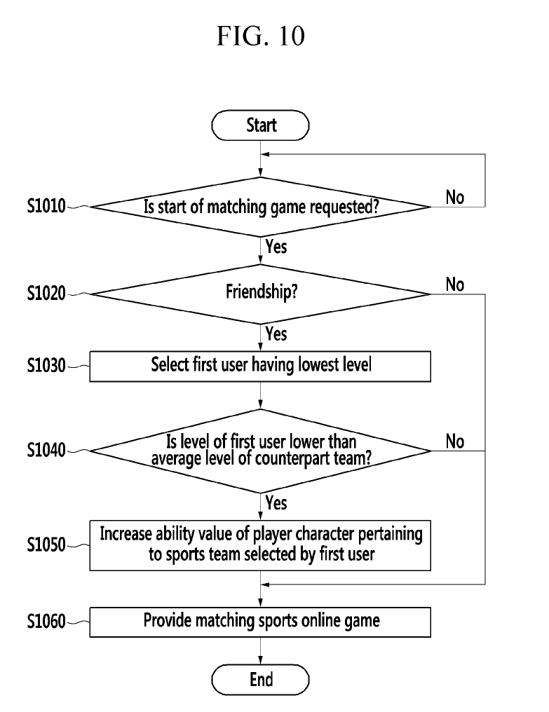

FIG. 10 is a flowchart for explaining a method for providing an online game in accordance with yet another exemplary embodiment. In the exemplary embodiment of FIG. 10, the ability value compensation is performed by determining whether to pertain to the same matching team previously.

The method for providing an sports game in accordance with the exemplary embodiment will be described with reference to FIG. 9. When receiving a request of starting a matching game for a first matching team and a second matching team each of which is configured by participation of a plurality of users (Yes, step S1010), the game providing system 100 may check whether the users who participate in the first matching team have a friendship with each other (step S920).

If the corresponding users have the friendship with each other (Yes, step S1020), the game providing system 100 selects a first user having the lowest level among the users pertaining to the first matching team (step S1030), and compares the level of the first user and an average level of the users pertaining to the matching team (step S1040).

As a result of comparing them, if the level of the first user is lower than the average level (step S1040), the game providing system 100 may perform compensation by increasing ability values of player characters pertaining to a sports team of the first user with a weight value proportional to the difference therebetween (step S1050).

The game providing system 100 may provide the matching sports online game for the pair of matching teams by applying the compensated result (step S1060).

In another exemplary embodiment for step S1050, the game providing system 100 may calculate a first weight value proportional to the difference between the average level and the level of the first user and determine an uniform item having a predetermined strengthening number of times corresponding to the first weight value, and then increase the ability value of at least one player character pertaining to the sports team of the first user by applying the uniform item to the player character.

In yet another exemplary embodiment for step S1050, the game providing system 100 may calculate a first weight value proportional to the difference between the average level and the level of the first user and increase the ability value of at least one player character pertaining to the sports team of the first user at a rate corresponding to the first weight in the provided matching game, thereby increasing the ability value of the player character.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

1. A method for providing an online sports game, performed by a system for providing the online sports game, which is connectable to a plurality of game clients through a network, to provide the online sports game to users through the game clients, the method comprising:
(a) receiving a request of starting a matching game for a pair of matching teams each of which is configured by participation of a plurality of users and checking whether the users who participate in each of the pair of matching teams have a friendship with each other;
if the corresponding users have the friendship,
(b) performing compensation by increasing ability values of player characters pertaining to a sports team of a first user having the lowest level among the users pertaining to the corresponding matching team; and
(c) providing the sports online game for the pair of matching teams by applying the compensated result.

2. The method of claim 1, further comprising,
if the corresponding users do not have the friendship,
(d) checking whether the users who participate in the corresponding matching team perform a setting to have a friendship.

3. The method of claim 1, wherein, if the users have the friendship, the (b) includes (b-1) providing an item for increasing ability values of at least one of the player characters pertaining to the sports team of the first user.

4. The method of claim 3, wherein the (b-1) includes
setting a first weight value for the level of the first user and a second weight value for a predetermined strengthening number of times at which a uniform item is to be strengthened; and
determining the uniform item to maintain a value obtained by multiplying the first weight value and the second weight value in a range.

5. The method of claim 1, wherein, if the users have the friendship, the (b) includes performing compensation by increasing the ability value of at least one play character pertaining to the sports team of the first user in the only case of the matching game.

6. The method of claim 1, wherein, if the users have the friendship, the (b) includes checking whether the level of the first user having the lowest level among the users pertaining to the corresponding matching team is equal to or lower than a predetermined level and, if the level of the first user is equal to or lower than the predetermined level, performing compensation by increasing the ability values of the player characters pertaining to the sports team of the first user.

7. The method of claim 1, wherein the (a) includes checking the users who participate in each of the pair of matching teams pertained to the same matching team at least one time or more, and
the (b) includes, if the users pertained to the matching team, checking whether the level of the first user having the lowest level among the users pertaining to the matching team is equal to or lower than a predetermined level and, if the level of the first user is equal to or lower than the predetermined level, performing compensation by increasing the ability values of the player characters pertaining to the sports team of the first user with a weight value proportional to a difference between the predetermined level and the level of the first user.

8. The method of claim 1, wherein the (a) includes receiving a request of starting a matching game for a first matching team and a second matching team each of which is configured by participation of a plurality of users and checking whether the users who participate in the first matching team have a friendship with each other, and
the (b) includes, if the users have the friendship, comparing an average level of the users who participate in the second matching team with a level of a first user having the lowest level among the users pertaining to the first matching team, and, as a result of comparing them, if the level of the first user is lower than the average level, performing compensation by increasing ability values of player characters pertaining to a sports team of the first user with a weight value proportional to a difference between the average level and the level of the first user.

9. The method of claim 8, wherein the (b) includes
calculating a first weight value proportional to the difference between the average level and the level of the first user;
determining a uniform item having a predetermined strengthening number of times corresponding to the first weight value; and
providing the uniform item for at least one player character of the sport team of the first user.

10. The method of claim 8, wherein the (b) includes
calculating a first weight value proportional to the difference between the average level and the level of the first user; and
performing compensation by increasing an ability value of at least one player character of the sport team of the first user at a rate corresponding to the first weight value in the only case of the matching game.

11. A system for providing an online sports game, which is connectable to a plurality of game clients through a network, to provide the online sports game to users through the game clients, the system comprising:
a user interface configured to store a level information, an information related to a managing sports team, and a friend information for each user of the online sports game;
a match organizer configured to organize a first matching team and a second matching team each of which is configured by a plurality of users; and
a game providing controller configured to check whether the users pertaining to the first and second matching teams have a relationship by using the user database and, if the users have the relationship, perform compensation by increasing ability values of at least some of player characters pertaining to a sports team of a first user who has the lowest level among the users pertaining to the corresponding matching team.

12. The system of claim 11, further comprising
a match information database configured to store a matching information,
wherein the game providing controller checks the relationship based on the friend information or the matching information.

13. The system of claim 11, wherein the game providing controller checks a user whose level is equal to or lower than a predetermined level among the users pertaining to the first and second matching teams, and performs control to increase an ability value of at least one of player characters pertaining to a sports team of the corresponding user.

14. The system of claim 11, further comprising
an item database configured to store an uniform item for increasing an ability value of a player character by being applied to the player character,
wherein the game providing controller provides the uniform item for at least one of the player characters pertaining to the sports team of the first user.

15. A computer readable recording medium recorded with a program for executing a method for providing a game service by a terminal,
wherein the program is drivable by a system for providing the online sports game, which is connectable to a plurality of game clients through a network, to provide the online sports game to users through the game clients, the program implements:
(a) receiving a request of starting a matching game for a pair of matching teams each of which is configured by participation of a plurality of users and checking whether the users who participate in each of the pair of matching teams have a friendship with each other;
if the corresponding users have the friendship,
(b) performing compensation by increasing ability values of player characters pertaining to a sports team of a first user having the lowest level among the users pertaining to the corresponding matching team; and
(c) providing the sports online game for the pair of matching teams by applying a result of the compensation.
